(19) United States
(12) Patent Application Publication
(10) Pub. No.: US 2020/0251868 A1
(43) Pub. Date: Aug. 6, 2020

(54) ELECTRICAL CONNECTOR ASSEMBLY

(71) Applicant: Molex, LLC, Lisle, IL (US)

(72) Inventors: Austin NICHOLSEN, Lisle, IL (US); Alan HAN, Lisle, IL (US); Victor ZADEREJ, Wheaton, IL (US); Kevin SIMONE, Bellevue, WA (US)

(73) Assignee: Molex, LLC, Lisle, IL (US)

(21) Appl. No.: 16/637,272

(22) PCT Filed: Aug. 13, 2018
(86) PCT No.: PCT/US2018/046493

§ 371 Date: Feb. 7, 2020

Related U.S. Application Data
(60) Provisional application No. 62/546,251, filed on Aug. 16, 2017.

(51) Int. Cl. H01R 35/04; H01R 13/50; H01R 13/629; H01R 13/28; H01R 43/16

(52) U.S. Cl. CPC H01R 35/04; H01R 13/501; H01R 43/16; H01R 13/28; H01R 13/629

(57) ABSTRACT

An electrical connector assembly provides a hinge between two parts, such as an eye-piece part and an arm-piece part of augmented eyewear. The assembly includes first and second hermaphroditic connectors which are rotatable relative to each other. Each connector includes a conductive electrical terminal disposed on a non-conductive support. Each electrical terminal includes a main body and a flexible contact arm extending therefrom, and a contacting protrusion protruding from the contact arm. The contact arm can be flexed into a slot in the support. The contacting protrusion on each arm maintains engagement with the main body of the other connector during rotation.

### RELATED APPLICATIONS

This application claims priority to U.S. Provisional Application Ser. No. 62/546,251, filed on Aug. 16, 2017, which is incorporated herein by reference in its entirety.

### TECHNICAL FIELD

This disclosure relates to the field of an electrical connector assembly and, more specifically, to an electrical connector assembly having a hinged element.

### DESCRIPTION OF RELATED ART

Electrical connector assemblies having a hinged element are suitable for use between at least two elements that rotate with respect to each other while maintaining electrical contact between the two elements during and after rotation. These types of connector assemblies are typically used with rotating hinged displays, slip rings that typically utilize a rotating contact ring and a deflectable contact.

### SUMMARY

An electrical connector assembly provides a hinge between two parts, such as an eye-piece part and an arm-piece part of augmented eyewear. The assembly includes first and second hermaphroditic connectors which are rotatable relative to each other. Each connector includes a conductive electrical terminal disposed on a non-conductive support. Each electrical terminal includes a main body and a flexible contact arm extending therefrom, and a contacting protrusion protruding from the contact arm. The contact arm can be flexed into a slot in the support. The contacting protrusion on each arm maintains engagement with the main body of the other connector during rotation.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF THE DRAWINGS

FIG. 1 is a perspective view of an electrical connector assembly in accordance with an embodiment of the present disclosure;

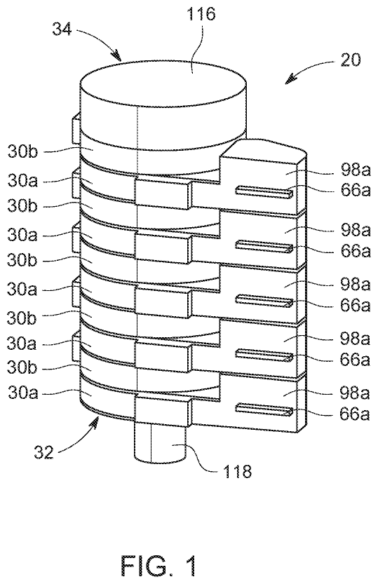

FIG. 2 is a top plan view of the electrical connector assembly assembled with a device;

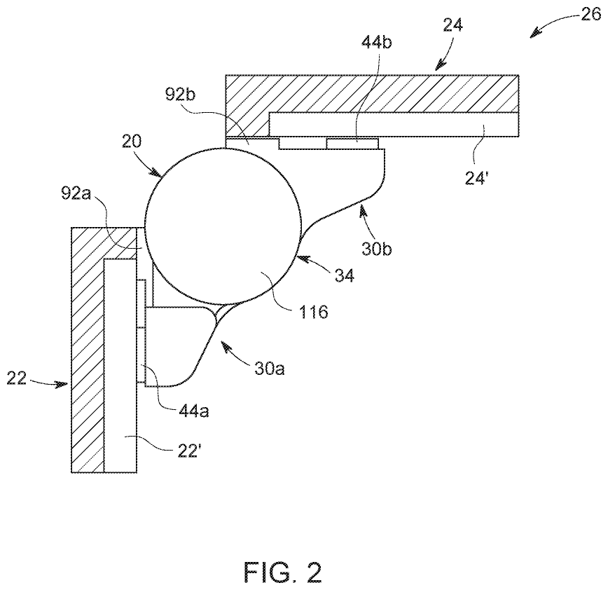

FIG. 3 is a partial exploded perspective view of the electrical connector assembly;

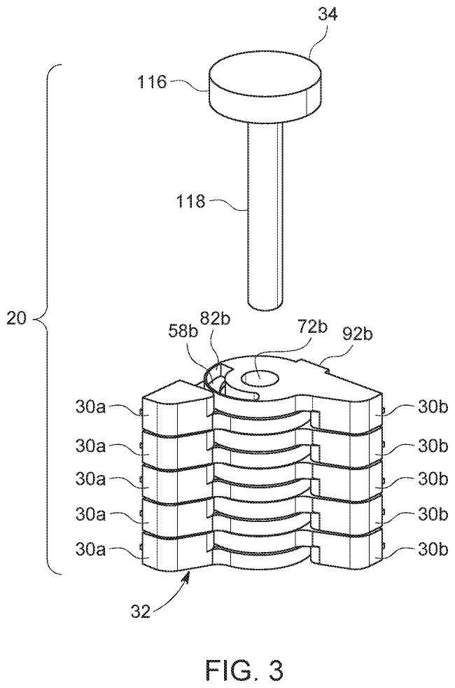

FIG. 4 is a partial cross-sectional view of a pair of connectors of the electrical connector assembly;

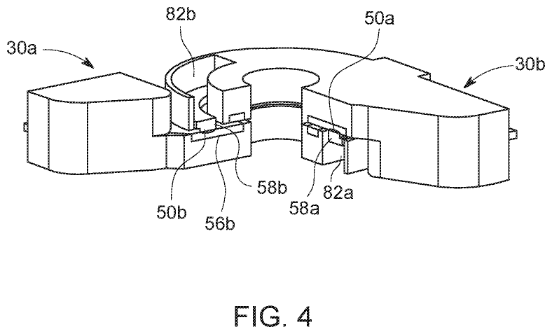

FIG. 5 is a top plan view of an electrical terminal of the electrical connector assembly;

FIG. 6 is a top plan view of a support of the electrical connector assembly;

FIG. 7 is an exploded perspective view of a connector of the electrical connector assembly;

FIG. 8 is an exploded perspective view of a pair of connectors of the electrical connector assembly;

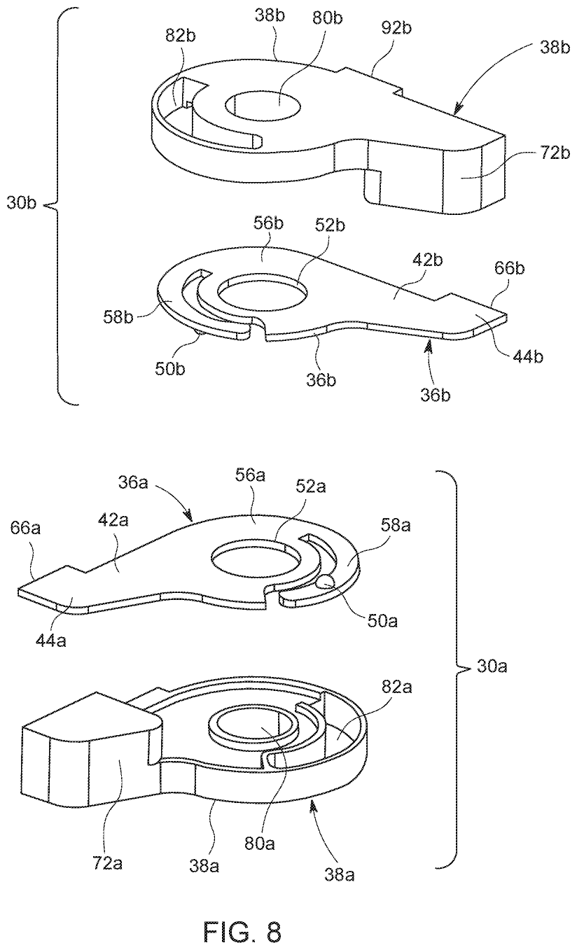

FIG. 9 is a top plan view of one of the connectors of the electrical connector assembly;

FIG. 10 is a perspective view of augmented eyewear which includes the electrical connector assembly; and

FIG. 11 is an alternate perspective view of the augmented eyewear of FIG. 9.

### DETAILED DESCRIPTION

While the disclosure may be susceptible to embodiment in different forms, there is shown in the drawings, and herein will be described in detail, specific embodiments with the understanding that the present disclosure is to be considered an exemplification of the principles of the disclosure and is not intended to limit the disclosure to that as illustrated and described herein. Therefore, unless otherwise noted, features disclosed herein may be combined to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

An electrical connector assembly 20 is provided to form a hinge between two parts 22, 24 of a device 26. Each part 22, 24 of the device 26 has electrical components 22′, 24′ thereon, and the electrical connector assembly 20 provides an electrical connection between the electrical components 22′, 24′ on the two parts 22, 24 while allowing the parts 22, 24 to rotate relative to each other. As shown in the drawings, the device 26 is shown as augmented eyewear. It is to be understood that the drawings illustrate an embodiment of the present disclosure and it is to be understood that the disclosed embodiment is merely exemplary of the disclosure, which may be embodied in various forms. Therefore, specific details disclosed herein are not to be interpreted as limiting, but merely as a basis for the claims and as a representative basis for teaching one skilled in the art to variously employ the present disclosure. For example, the device 26 could be provided as part of a car (for example, the electrical connector assembly 20 providing a hinge for the car door), as part of an appliance (for example, the electrical connector assembly 20 providing a hinge for the appliance door), etc.

The electrical connector assembly 20 includes at least one pair of connectors 30a, 30b that are arranged in a vertical stacked relationship to form a connector stack 32, and a hinge pin 34 extending through the connector stack 32 and around which the at least one pair of connectors 30a, 30b can rotate. The connector 30a, 30b in each pair can rotate relative to each other around the hinge pin 34. Connector(s) 30a are affixed to and electrically connected to part 22, and connector(s) 30b are affixed to and electrically connected to part 24. While five pairs of connectors 30a, 30b are shown, more or less than five pairs of connectors 30a, 30b may be provided, The number of pairs of connectors 30a, 30b can be adjusted according to a desired number of circuits required for the functional features needed in the device 26.

Each connector 30a, 30b is identical and the connectors 30a, 30b are arranged in an alternating mirrored relationship, and therefore, a single connector 30a is described, with the understanding that the other connectors 30b have the same reference numeral for the identical features, but are shown with the suffix “b”. The connector 30a includes an electrical terminal 36a and a housing or support 38a on which the electrical terminal 36a is mounted.

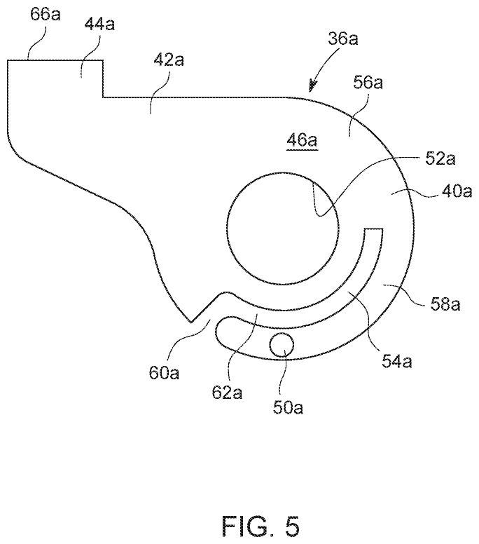

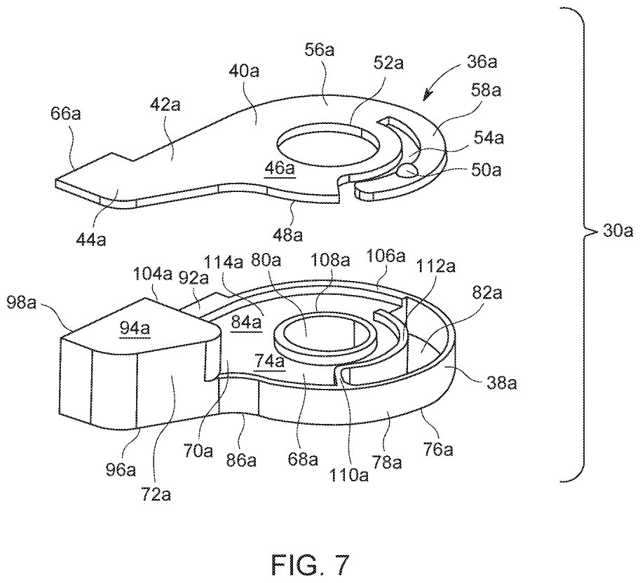

The electrical terminal 36a is formed of an electrically conductive material. The electrical terminal 36a may be formed by a stamping and forming. The electrical terminal 36a may be formed from a resilient electrically conductive flat stock, generally copper or copper-based alloy. As best shown in FIGS. 5 and 7, the electrical terminal 36a has a base section 40a, a mounting section 42a extending from the base section 40a, and a tab section 44a extending from the mounting section 42a.

The base section 40a has a first surface 46a and a second, opposite surface 48a. In an embodiment, the surfaces 46a, 48a are planar, with the exception of a contacting projection 50a discussed herein. In an embodiment, the base section 40a is circular in configuration. An aperture 52a is formed through the base section 40a between the surfaces 46a, 48a, and in an embodiment, the aperture 52a is formed in a center of the base section 40a, An elongated slot 54a is formed in the base section 40a between the surfaces 46a, 48a to divide the base section 40a into a main body 56a and a contact arm 58a. The elongated slot 54a includes an entrance portion 60a having an outer end that extends from an outer periphery of the base section 40a and an extending portion 62a which extends from an inner end of the entrance portion 60a. In an embodiment, the entrance portion 60a extends radially relative to a center of the base section 40a, and the extending portion 62a follows an arcuate shape that is radially spaced from the center of the base section 40a. The contact arm 58a is thus cantilevered from the main body 56a such that a first end of the contact arm 58a is integrally formed with the main body 56a and a second end of the contact arm 58a is free. In an embodiment, the contact arm 58a is curved. The contacting projection 50a extends from the first surface 46a of the contact arm 58a along its length. In an embodiment, the contacting projection 50a. extends from the contact arm 58a at a position which is proximate to, but spaced from, the second free end. The slot 54a allows the contact arm 58a to flex relative to the main body 56a.

The mounting section 42a extends outwardly from the base section 40a. The mounting section 42a has a first surface and a second, opposite surface. In an embodiment, the surfaces are planar. The mounting section 42a may extend from an opposite side of the base section 40a from which the contact arm 58a is provided. In an embodiment, the mounting section 42a has a first end at the base section 40a which is wider than a second opposite end of the mounting section 42a.

The tab section 44a extends outwardly from the second end of the mounting section 42a to a free end 66a. The tab section 44a has a first surface and a second, opposite surface. In an embodiment, the surfaces are planar. In an embodiment, the tab section 44a is angled relative to the mounting section 42a. In an embodiment, the tab section 44a is perpendicular to the mounting section 42a.

In an embodiment, the first surfaces of the base section 40a, the mounting section 42a and the tab section 44a are co-planar with each other when the contact arm 58a is unflexed, with the exception of the contacting projection 50a, and the second surfaces of the base section 40a, the mounting section 42a and the tab section 44a are co-planar with each other when the contact arm 58a is unflexed.

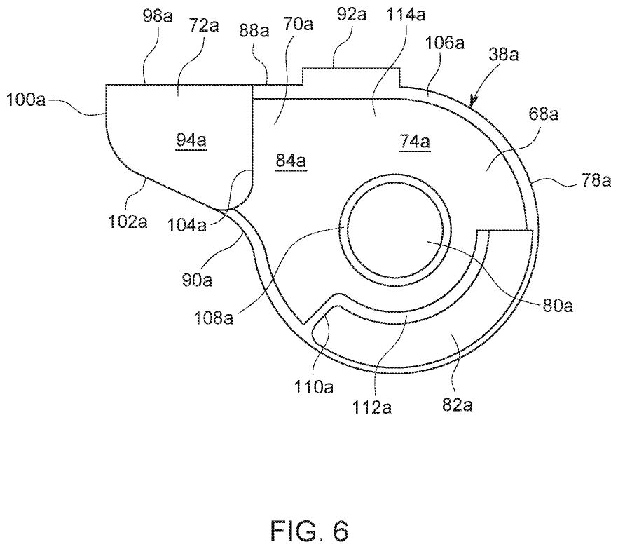

The support 38a is formed over/around the electrical terminal 36a in order to provide protection and support to the electrical terminal 36a. The support 38a is formed of a non-conductive material. As best shown in FIGS. 6 and 7, the support 38a has a base section 68a, a mounting section 70a extending from the base section 68a, and a tab section 72a extending from the mounting section 70a.

The base section 68a has a first surface 74a, a second, opposite surface 76a and a side surface 78a extending therebetween. In an embodiment, the surfaces 74a, 76a are planar. An aperture 80a is formed through the base section 68a between the surfaces 74a, 76a, and in an embodiment, the aperture 80a is formed in a center of the base section 68a. In an embodiment, the base section 68a is circular in configuration and slightly larger than the base section 40a. An elongated slot 82a is formed though the base section 68a, extends between the surfaces 74a, 76a, and is dimensioned such that the contact arm 58a can pass therein. The slot 82a has first and second ends, with an outer side wall extending between the ends, and an inner side wall extending between the ends. In an embodiment, the slot 82a is radially spaced from a center of the base section 68a and follows an arcuate shape. In an embodiment, the elongated slot 82a mirrors the shape of the contact arm 58a but is slightly larger than the contact arm 58a.

The mounting section 70a extends outwardly from the base section 68a. The mounting section 70a has a first surface 84a, a second, opposite surface 86a and side surfaces 88a, 90a extending therebetween. In an embodiment, the first and second surfaces 84a, 86a are planar. The mounting section 70a may extend from an opposite side of the base section 68a from which slot 82a is provided. In an embodiment, the mounting section 70a has a first end at the base section 68a which is wider than a second opposite end of the mounting section 70a. In an embodiment, the first surfaces 74a, 84a of the base section 68a and the mounting section 70a are co-planar with each other and the second surfaces 76a, 86a of the base section 68a and the mounting section 70a are co-planar with each other, A flange 92a extends outwardly from the side surface 88a of the mounting section 70a and may extend between the first and second surfaces 84a, 86a of the mounting section 70a.

The tab section 72a has a first surface 94a, a second, opposite surface 96a and side surfaces 98a, 100a, 102a extending therebetween. In an embodiment, the first and second surfaces 94a, 96a are planar. The side surface 98a may be co-planar with side surface 88a. A first end of the tab section 72a extends from the second end of the mounting section 70a, In an embodiment, the first surface 94a of the tab section 72a is offset from the first surfaces 74a, 84a of the base section 68a and the mounting section 70a such that the tab section 72a has a greater height than the base section 68a and a shoulder wall 104a is formed at the junction with the mounting section 70a, In an embodiment, the second surfaces 76a, 86a, 96a of the base section 68a, the mounting section 70a and the tab section 72a are co-planar with each other.

A first wall 106a extends from the first surfaces 74a, 84a at the outer periphery of the base section 68a and the mounting section 70a and extends from the shoulder wall 104a, a second wall 108a extends from the first surface 74a of the base section 68a around the aperture 80a, a third wall 110a extends from the first surface 84a of the base section 68a and is proximate to the second end of the slot 82a, and a fourth wall 112a extends from the first surface 74a of the base section 68a and is proximate to the inner side wall of the slot 82a. The third wall 110a extends inwardly from the first wall 106a and the fourth wall 112a extends from an inner end of the third wall 110a. In an embodiment, the third wall 110a extends radially relative to the center of the base section 68a, and the fourth wall 1 12a follows an arcuate shape that is radially spaced from the center of the base section 68a. The third wall 110a is dimensioned to fit within the entrance portion 60a of the slot 54a in the electrical terminal 36a, and the fourth wall 112a is dimensioned to fit within the extending portion 62a of the slot 54a in the electrical terminal 36a. The walls 104a, 106a, 108a, 110a, 112a form a recess 114a in the support 38a. The shoulder wall 104a may have a greater height than the walls 106a, 108a, 110a, 112a. The walls 106a, 108a, 110a, 112a may have the same height or varying heights.

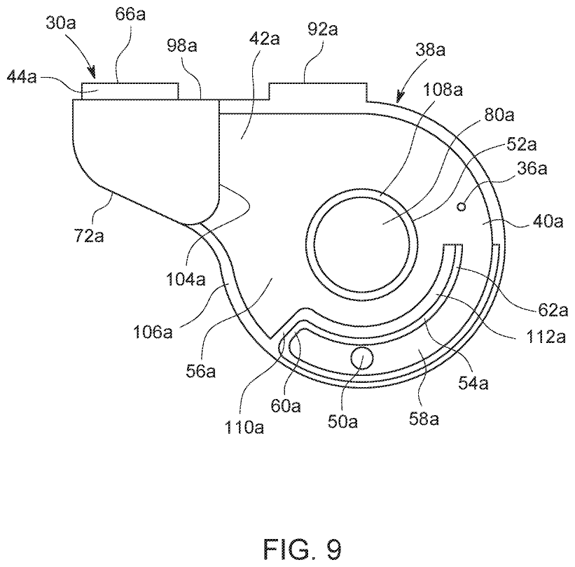

The electrical terminal 36a is mounted to the support 38a as shown in FIG. 9. The base section 40a of the electrical terminal 36a is seated within the recess 114a. The third wall 110a of the support 38a seats within the entrance portion 60a of the slot 54a in the electrical terminal 36a, the fourth wall 112a of the support 38a seats within the extending portion 62a of the slot 54a in the electrical terminal 36a, and the contact arm 58a is positioned over the slot 82a. The second wall 108a of the support 38a seats within the aperture 52a in the electrical terminal 36a. The mounting section 42a of the electrical terminal 36a seats partially within the recess 114a. and extends partially through the tab section 72a of the support 38a, The tab section 44a of the electrical terminal 36a extends partially through the tab section 72a of the support 38a and the end 66a of the tab section 44a of the electrical terminal 36a extends outwardly from the side surface 98a of the tab section 72a of the support 38a, thereby exposing a portion of the tab section 44a of the electrical terminal 36a on the exterior of the support 38a. The flange 92a extends outwardly from the mounting section 70a on the same side of the connector 30a as where the tab section 72a extends.

The connectors 30a, 30b are vertically stacked on each other to form pairs of connectors 30a, 30b, In each pair, the electrical terminals 34a, 34b face each other and the contacting projection 50a on the connector 30a contacts the base section 40b of the connector 30b and is in electrical engagement therewith, and the contacting projection 50b on the connector 30b contacts the base section 40a of the connector 30a and is in electrical engagement therewith. The slots 82a, 82b allow the contact arms 58a, 58b to flex. The apertures 52a, 80a, 52b, 80b align with each other to form a passageway and define an axis around which the connectors 30a, 30b rotate. In this arrangement, each connector 30a, 30b is positioned in an alternating mirrored relationship, in other words, a hermaphroditic arrangement, wherein each electrical terminal 36a, 36b faces, and is exposed to, the other electrical terminal 36a, 36b of the connector 30a, 30b in the pair.

The hinge pin 34 extends through the aligned apertures 52a, 80a, 52b, 80b and is secured to the pair of connectors 30a, 30b (and any remaining pairs 30a, 30b when provided). The hinge pin 34 includes an enlarged head 116 with a post 118 extending from the head 116. The post 118 of the hinge pin 34 is disposed in the aligned apertures 52a, 80a, 52b, 80b securing the adjacent connectors 30a, 30b together. The post 118 of the hinge pin 34 engages the walls forming the apertures 80a, 80b in the supports 38a, 38b such that any lateral or side loads are applied to the supports 38a, 38b of the connectors 30a, 30b rather than to the electrical terminals 36a, 36b of the connectors 30a, 30b, A fastener (not shown) may be provided on the end of the post 118 to secure the hinge pin 34 to the connector stack 32. The end of the post 118 may be swaged to secure the hinge pin 34 to the connector stack 32.

In each pair of connectors 30a, 30b, the tab section 44a of the electrical terminal 36a is electrically connected to the electrical components 22′ in the first part 22 of the device 26 and the flange 92a seats against the first part 22 of the device 26; and the tab section 44b on the second connector 30b is electrically connected to the electrical components 24′ in the second part 24 of the device 26 and the flange 92b seats against the second part 24 of the device 26. Adjacent pairs of the connectors 30a, 30b have the second surfaces 76a, 76b of the supports 38a, 38b facing each other. The tab sections 44a, 44b are configured to be surface mounted to the electrical components 22′, 24′ which may be formed as rigid or flexible circuit boards in each part 22, 24. The stacked connectors 30b, 30b are interleaved together in the connector stack 32.

In operation, one connector rotates with respect to the other connector, for example connector 30a rotates with respect to connector 30b, and the contacting projection 50a is biased to the main body 56b of the opposing terminal 36b. The contacting projection 50a rides on the main body 56b and deflects the contact arm 58a in an axial direction away from the point of contact and into the corresponding slot 82a formed in the support 38a, and therefore causing a reactionary or normal force between the contacting projection 50a on the electrical terminal 36a on the connector 30a and the base section 40b of the electrical terminal 36b of the connector 30b, and contacting projection 50b rides on the main body 56a and deflects the contact arm 58b in an axial direction away from the point of contact and into the corresponding slot 82b formed in the support 38b, and therefore causing a reactionary or normal force between the contacting projection 50b on the electrical terminal 36b on the connector 30b and the base section 40a of the electrical terminal 36a of the connector 30a, thereby maintaining constant electrical engagement between the connectors 30a, 30b at all times during rotation.

As shown in the drawings, the electrical connector assembly 20 is shown in a 90-degree arrangement so that in operation, when the device 26 is in the open position and moved to the closed or folded position, the electrical connector assembly 20 operates between a 90-degree position and a 0-degree position respectively. In other arrangements, the electrical connector assembly 20 can be operated with a 180-degree to 90-degree stroke. In this case, the electrical connector assembly 20 would be flat or in-line at 180-degrees in the open position and at 90-degrees in the folded or closed position. Other angular strokes and range of movements are contemplated within the scope of the disclosure and not limited to the illustrated examples.

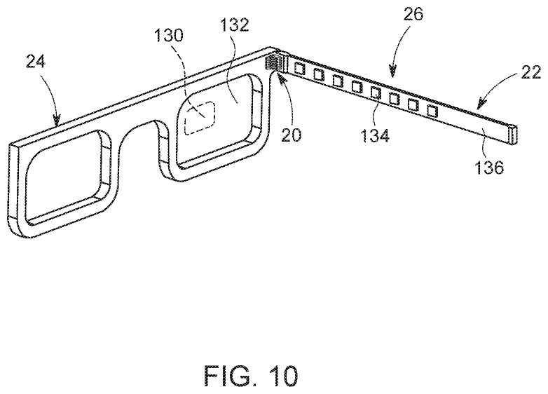

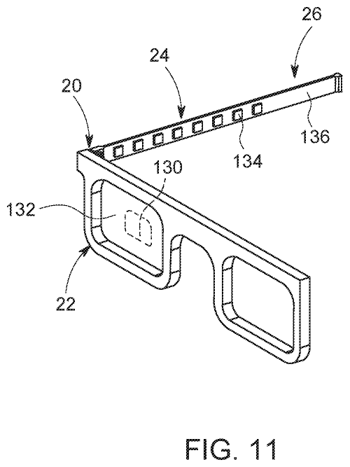

As shown in FIGS. 10 and 11, the device 26 is augmented eyewear and the first part 22 is an eye-piece part and the second part 24 is an arm-piece part. A second arm-piece part is typically also provided, but may have a different hinge as an electrical connection may not be needed. Typically, augmented eyewear includes a display device 130 that is incorporated either into a lens 132 or in proximity to the lens 132 on the eye-piece part, and the associated electrical components 134 to drive the display device 130 are arranged on one of the arm-piece parts. The second part 24 formed by the arm-piece part includes an arm base 136 with associated electrical components 134 mounted thereon. The arm base 136 may include the electrical component 24′ for mounting the electrical components 134 or the electrical components 134 may be directly mounted on the arm base 136 in a MID (Molded Interconnect Device) structure. Additionally, some embodiments include an Application Specific Electronics Packaging (“ASEP”) system, which enables the manufacture of additional products using reel to reel (continuous flow) manufacturing processes as opposed to the “batch” processes used to currently manufacture electronic products. Through certain ASEP embodiments, it is possible to integrate connectors, sensors, LEDs, thermal management, antennas, RFID devices, microprocessors, memory, impedance control, and multi-layer functionality directly into the device. Reference to ASEP packaging systems and methods are described in PCT publication WO1700406A1 owned by Molex, LLC. It can be appreciated that the eyewear depicted in the drawings is purely illustrative and encompasses the minimum structure that illustrates the functionality of the eyewear. Style considerations and other human effect features are purposely not included in the description and the lack therefore is not limiting.

While particular embodiments are illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims.

We claim:

1. An electrical connector assembly configured to provide a hinge between electrical components on two parts, comprising:
a first connector and a second connector, the connectors being hermaphroditic, each connector including a conductive electrical terminal and a non-conductive support on which the electrical terminal is disposed, the electrical terminal including a main body and a contact arm extending therefrom, and a contacting protrusion extending from the contact arm, wherein the contact arm can be flexed relative to the main body, the support having a slot therethrough, the contact arm being proximate to the slot such that the contact arm can be flexed into the slot; and
a hinge pin extending through the connectors, the connectors being rotatable around hinge pin,
wherein when the first connector is mated with the second connector, the contacting protrusion of the first connector engages with the main body of the second connector and the contacting protrusion of the second connector engages with the main body of the first connector, and
wherein during rotation of the connectors relative to each other, the contacting protrusion of the first connector maintains engagement with the main body of the second connector and the contacting protrusion of the second connector maintains engagement with the main body of the first connector.

2. The electrical connector assembly as defined in claim 1, wherein in each connector, the electrical terminal is partially disposed in a recess in the respective support.

3. The electrical connector assembly as defined in claim 2, wherein in each connector, the electrical terminal partially passes through a portion of the respective support such that an end portion of the respective electrical terminal extends outwardly from the respective connector.

4. The electrical connector assembly as defined in claim 1. wherein each contact arm is curved.

5. The electrical connector assembly as defined in claim 4, wherein each slot is curved.

6. The electrical connector assembly as defined in claim 1, wherein each support has a first surface on which the electrical contact is seated, a second opposite surface, and an outer wall extending between the surfaces, and wherein a portion of the outer wall of each support follows an arcuate shape.

7. The electrical connector assembly as defined in claim 6, wherein each contact arm is curved.

8. The electrical connector assembly as defined in claim 7, wherein each slot is curved.

9. The electrical connector assembly as defined in claim 6, wherein each second surface is planar.

10. The electrical connector assembly as defined in claim 1, further comprising:
a third connector and a fourth connector, the connectors being hermaphroditic, each connector including a conductive electrical terminal and a non-conductive support on which the electrical terminal is disposed, the electrical terminal including a main body and a contact arm extending therefrom, and a contacting protrusion extending from the contact arm, wherein the contact arm can be flexed relative to the main body, the support having a slot therethrough, the contact arm being proximate to the slot such that the contact arm can be flexed into the slot; and
the hinge pin extending through the third and fourth connectors, the third and fourth connectors being rotatable around the hinge pin,
wherein when the third connector is mated with the fourth connector, the contacting protrusion of the third connector engages with the main body of the fourth connector and the contacting protrusion of the fourth connector engages with the main body of the third connector, and
wherein during rotation of the connectors relative to each other, the contacting protrusion of the third connector maintains engagement with the main body of the fourth connector and the contacting protrusion of the fourth connector maintains engagement with the main body of the third connector.

11. The electrical connector assembly as defined in claim 10, wherein each contact arm is curved.

12. The electrical connector assembly as defined in claim 11, wherein each slot is curved.

13. A device comprising:
a first part having a first electrical component;
a second part having a second electrical component; and
an electrical connector assembly that provides an electrical connection between the first and second electrical components while allowing the first and second parts to rotate relative to each other, the electrical connector assembly comprising:
a first connector and a second connector, the connectors being hermaphroditic, each connector including a conductive electrical terminal and a non-conductive support on which the electrical terminal is disposed, the electrical terminal including a main body and a contact arm extending therefrom, and a contacting protrusion extending from the contact arm, wherein the contact arm can be flexed relative to the main body, the support having a slot therethrough, the contact arm being proximate to the slot such that the contact arm can be flexed into the slot, the first connector being electrically connected to the first electrical component, and the second connector being electrically connected to the second electrical component; and
a hinge pin extending through the connectors, the connectors being rotatable around the hinge pin,
wherein when the first connector is mated with the second connector, the contacting protrusion of the first connector engages with the main body of the second connector and the contacting protrusion of the second connector engages with the main body of the first connector, and
wherein during rotation of the connectors relative to each other, the contacting protrusion of the first connector maintains engagement with the main body of the second connector and the contacting protrusion of the second connector maintains engagement with the main body of the first connector.

14. The device as defined in claim 13, wherein in each connector, the electrical terminal is partially disposed in a recess in the respective support.

15. The device as defined in claim 14, wherein in each connector, the electrical terminal partially passes through a portion of the respective support such that an end portion of the respective electrical terminal extends outwardly from the respective connector.

16. The device as defined in claim 13, wherein each connector includes at least one wall forming a recess in which the electrical terminal is mounted.

17. The device as defined in claim 13, wherein each contact arm is curved.

18. The device as defined in claim 17, wherein each slot is curved.

19. The device as defined in claim 13, further comprising:
a third connector and a fourth connector, the connectors being hermaphroditic, each connector including a conductive electrical terminal and a non-conductive support on which the electrical terminal is disposed, the electrical terminal including a main body and a contact arm extending therefrom, and a contacting protrusion extending from the contact arm, wherein the contact arm can be flexed relative to the main body, the support having a slot therethrough, the contact arm being proximate to the slot such that the contact arm can be flexed into the slot, the third connector being electrically connected to the first electrical component, and the fourth connector being electrically connected to the second electrical component; and
the hinge pin extending through the third and fourth connectors, the third and fourth connectors being rotatable around the hinge pin,
wherein when the third connector is mated with the fourth connector, the contacting protrusion of the third connector engages with the main body of the fourth connector and the contacting protrusion of the fourth connector engages with the main body of the third connector, and
wherein during rotation of the connectors relative to each other, the contacting protrusion of the third connector maintains engagement with the main body of the fourth connector and the contacting protrusion of the fourth connector maintains engagement with the main body of the third connector.

20. The device as defined in claim 13, wherein the device is augmented eyewear, wherein the first part is an eye-piece part, wherein the first electrical component is a display device associated with the eye-piece part, wherein the second part is an arm-piece part, and wherein the second electrical component is provided on the arm-piece part and is configured to drive the display device.
